(19) United States
(12) Patent Application Publication
(10) Pub. No.: US 2008/0065282 A1
(43) Pub. Date: Mar. 13, 2008

(54) System and method of multi-generation positive train control system

(76) Inventors: Wolfgang Daum, Erie, PA (US); John Hershey, Ballston Lake, NY (US); Randall Markley, Melbourne, FL (US); Paul Julich, Indialantic, FL (US); Mitchell Scott Wills, Melbourne, FL (US)

Correspondence Address: Patrick D. McPherson;Duane Morris LLP, Suite 700, 1667 K Street, N.W., Washington, DC, 20006, US

(21) Appl. No.: 11/518,250

(22) Filed: Sep. 11, 2006

(51) Int. Cl. G05D 1/00

(52) U.S. Cl. 701/19

(57) ABSTRACT

A method of scheduling the movement of trains as a function of the predicted crew behavior and predicted rail conditions.

### RELATED APPLICATIONS

The present application is related to the commonly owned U.S. patent application Ser. No. 11/415,273 entitled “Method of Planning Train Movement Using A Front End Cost Function”, Filed May 2, 2006, and U.S. patent application Ser. No. 11/476,552 entitled “Method of Planning Train Movement Using A Three Step Optimization Engine”, Filed Jun. 29, 2006, both of which are hereby incorporated herein by reference.

### BACKGROUND OF THE INVENTION

The present invention relates to the scheduling the movement of plural trains through a rail network, and more specifically, to the scheduling of the movement of trains over a railroad system based on the predicted performance of the trains.

Systems and methods for scheduling the movement of trains over a rail network have been described in U.S. Pat. Nos. 6,154,735, 5,794,172, and 5,623,413, the disclosure of which is hereby incorporated by reference.

As disclosed in the referenced patents and applications, the complete disclosure of which is hereby incorporated herein by reference, railroads consist of three primary components (1) a rail infrastructure, including track, switches, a communications system and a control system; (2) rolling stock, including locomotives and cars; and, (3) personnel (or crew) that operate and maintain the railway. Generally, each of these components are employed by the use of a high level schedule which assigns people, locomotives, and cars to the various sections of track and allows them to move over that track in a manner that avoids collisions and permits the railway system to deliver goods to various destinations.

As disclosed in the referenced patents and applications, a precision control system includes the use of an optimizing scheduler that will schedule all aspects of the rail system, taking into account the laws of physics, the policies of the railroad, the work rules of the personnel, the actual contractual terms of the contracts to the various customers and any boundary conditions or constraints which govern the possible solution or schedule such as passenger traffic, hours of operation of some of the facilities, track maintenance, work rules, etc. The combination of boundary conditions together with a figure of merit for each activity will result in a schedule which maximizes some figure of merit such as overall system cost.

As disclosed in the referenced patents and applications, and upon determining a schedule, a movement plan may be created using the very fine grain structure necessary to actually control the movement of the train. Such fine grain structure may include assignment of personnel by name, as well as the assignment of specific locomotives by number, and may include the determination of the precise time or distance over time for the movement of the trains across the rail network and all the details of train handling, power levels, curves, grades, track topography, wind and weather conditions. This movement plan may be used to guide the manual dispatching of trains and controlling of track forces, or may be provided to the locomotives so that it can be implemented by the engineer or automatically by switchable actuation on the locomotive.

The planning system is hierarchical in nature in which the problem is abstracted to a relatively high level for the initial optimization process, and then the resulting course solution is mapped to a less abstract lower level for further optimization. Statistical processing is used at all levels to minimize the total computational load, making the overall process computationally feasible to implement. An expert system is used as a manager over these processes, and the expert system is also the tool by which various boundary conditions and constraints for the solution set are established. The use of an expert system in this capacity permits the user to supply the rules to be placed in the solution process.

Currently, the movements of trains are typically controlled in a gross sense by a dispatcher, but the actual control of the train is left to the crew operating the train. Because compliance with the schedule is, in large part, the prerogative of the crew, it is difficult to maintain a very precise schedule. As a result it is estimated that the average utilization of these capital assets in the United States is less than 50%. If a better utilization of these capital assets can be attained, the overall cost effectiveness of the rail system will accordingly increase.

Another reason that the train schedules have not heretofore been very precise is that it has been difficult to account for the factors that affect the movement of trains when setting up a schedule. These difficulties include the complexities of including in the schedule the determination of the effects of physical limits of power and mass, speed limits, the limits due to the signaling system and the limits due to safe handling practices, which include those practices associated with applying power and braking in such a manner to avoid instability of the train structure and hence derailments. One factor that has been consistently overlooked in the scheduling of trains is the effect of the behavior of a specific crew on the performance of the movement of a train.

The present application is directed to planning the movement of trains based on the predicted performance of the trains as a function of the crew assigned to the train and the conditions of the railroad.

These and many other objects and advantages of the present disclosure will be readily apparent to one skilled in the art to which the disclosure pertains from a perusal of the claims, the appended drawings, and the following detailed description of the embodiments.

### BRIEF DESCRIPTION OF THE DRAWINGS

FIG. 1A is a simplified pictorial representation of a prior art rail system.

FIG. 1B is a simplified pictorial representation of the rail system of FIG. 1A divided into dispatch territories.

FIG. 2 is a simplified illustration of a merged task list for the combined dispatch territories of FIG. 1B.

FIG. 3A is a simplified pictorial representation of two consists approaching a merged track.

FIGS. 3B and 3C are simplified graphical representations of the predicted behavior of the consists from FIG. 3A in accordance with one embodiment of the present disclosure.

FIG. 4 is a simplified flow diagram of one embodiment of the present disclosure utilizing a behavior prediction model.

### DETAILED DESCRIPTION

As railroad systems continue to evolve, efficiency demands will require that current dispatch protocols and methods be upgraded and optimized. It is expected that there will be a metamorphosis from a collection of territories governed by manual dispatch procedures to larger territories, and ultimately to a single all-encompassing territory, governed by an automated dispatch system.

At present, dispatchers control within a local territory. This practice recognizes the need for a dispatcher to possess local knowledge in performing dispatcher duties. As a result of this present structure, train dispatch is at best locally optimized. It is a byword in optimization theory that local optimization is almost invariably globally suboptimal. To move to fewer but wider dispatch territories would require significantly more data exchange and concomitantly much greater computational power in order to optimize a more nearly global scenario.

In one aspect of the present disclosure, in order to move forward in broadening and consolidating dispatch territories, it is desirable to identify and resolve exceptions at a centralized location or under a centralized authority. As the automation of dispatch control and exception handling progresses, the dispatch routines will be increasingly better tuned and fewer exceptions will arise. In another aspect, all rail traffic information, rail track information including rail track conditions, weather data, crew scheduling and availability information, is collected and territory tasks and their priorities across the broadened territory are merged, interleaved, melded, to produce a globally optimized list of tasks and their priorities.

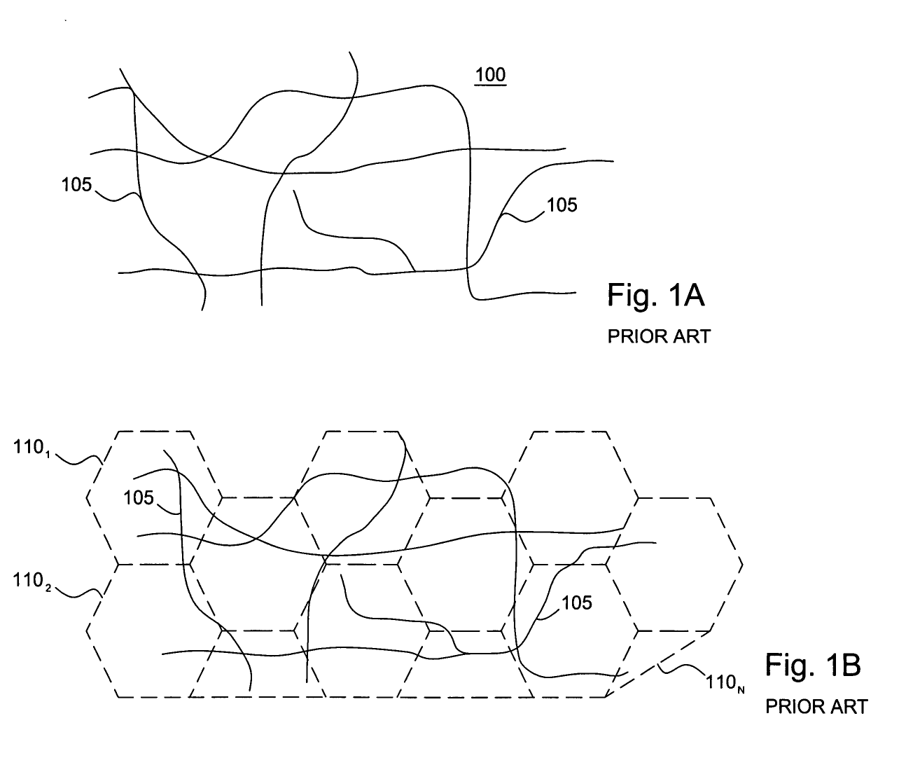

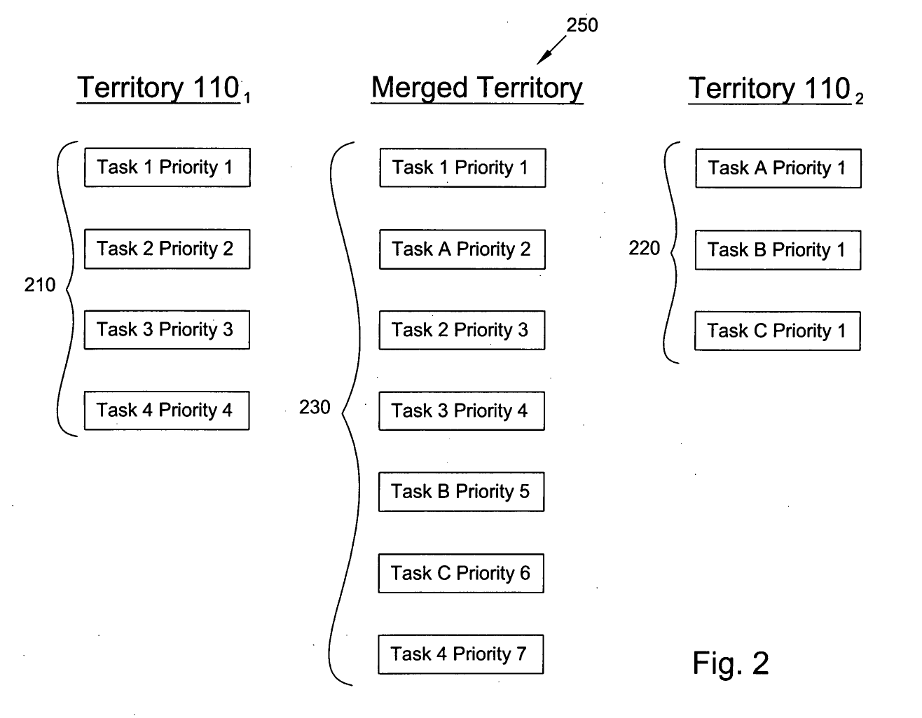

FIG. 1A illustrates a global rail system 100 having a network of tracks 105. FIG. 1B represents the global rail system partitioned into a plurality of dispatch territories 110₁, 110₂ . . . 110_{N}. FIG. 2 represents one embodiment of the present disclosure wherein a prioritized task list is generated for combined dispatch territories 110₁ and 110₂. Territory 110₁ has a lists of tasks in priority order 210. Territory 110₂ has a list of tasks for its associated dispatch territory in priority order 220. The two territory task lists are merged to serve as the prioritized task list 230 for the larger merged territory of 110₁ and 110₂. The merging and assignment of relative priorities can be accomplished by a method identical or similar to the method used to prioritize the task list for the individual territories that are merged. For example, the prioritized task list can be generated using well known algorithms that optimize some parameter of the planned movement such as lowest cost or maximum throughput or maximum delay of a particular consist.

In another aspect of the present disclosure, the past behavior of a train crew can be used to more accurately predict train performance against the movement plan, which becomes a more important factor as dispatch territories are merged. Because the actual control of the train is left to the engineer operating the train, there will be late arrivals and in general a non-uniformity of behavior across train movements and the variance exhibited across engineer timeliness and other operational signatures may not be completely controllable and therefore must be presumed to persist. The individual engineer performances can reduce the dispatch system's efficiency on most territorial scales and certainly the loss of efficiency becomes more pronounced as the territories grow larger.

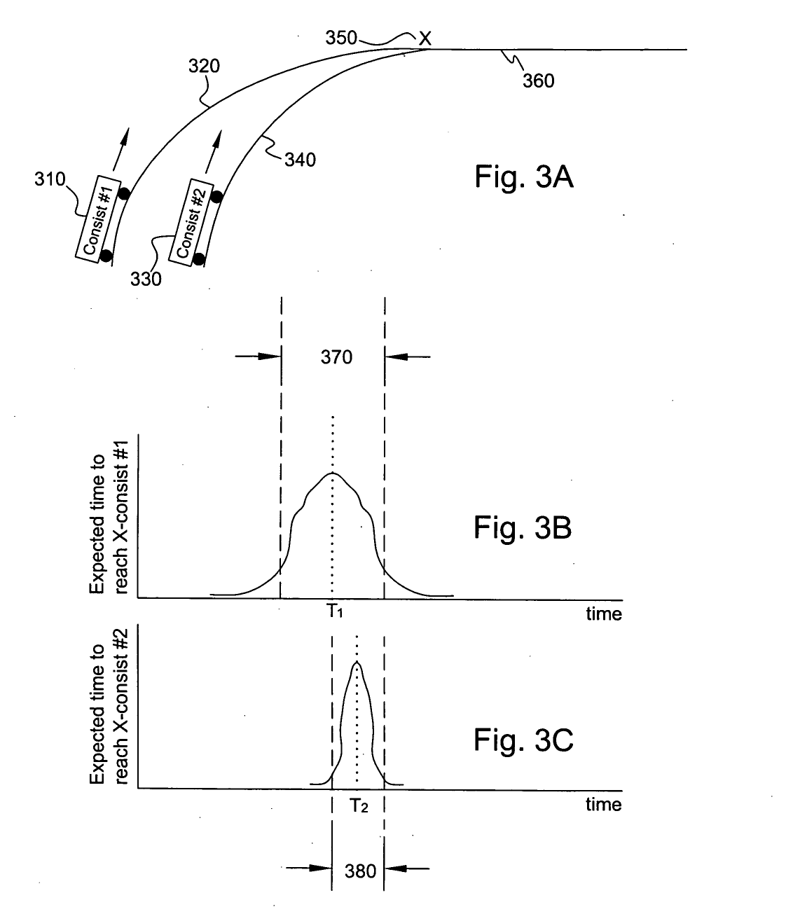

In one embodiment, a behavioral model for each crew can be created using an associated transfer function that will predict the movements and positions of the trains controlled by that specific crew under the railroad conditions experienced at the time of prediction. The transfer function is crafted in order to reduce the variance of the effect of the different crews, thereby allowing better planning for anticipated delays and signature behaviors. The model data can be shared across territories and more efficient global planning will result. FIG. 3A is an example illustrating the use of behavioral models for crews operating consist #1 310 and consist #2 330. Consist #1 310 is on track 320 and proceeding to a track merge point 350 designated by an ‘X’ Consist #2 330 is on track 340 and is also proceeding towards the merge point 350. At the merge point 350 the two tracks 320 and 340 merge to the single track 360. The behavior of the two consists under control of their respective crews are modeled by their respective behavior models, which take into account the rail conditions at the time of the prediction. The rail conditions may be characterized by factors which may influence the movement of the trains including, other traffic, weather, time of day, seasonal variances, physical characteristics of the consists, repair, maintenance work, etc. Another factor which may be considered is the efficiency of the dispatcher based on the historical performance of the dispatcher in like conditions.

Using the behavior model for each consist, a graph of expected performance for each consist can be generated. FIG. 3B is a graph of the expected time of arrival of consist #1 310 at the merge point 350. FIG. 3 is a graph of the expected time of arrival of consist #2 330 at the merge point 350. Note that the expected arrival time for consist #1 is T₁ which is earlier than the expected arrival time at the merger point 350 for consist #2 which is T₂, that is T₁<T₂.

The variance of expected arrival time 370 for consist #1 310 is however much larger than the variance of expected arrival time 380 for consist #2 330 and therefore the railroad traffic optimizer may elect to delay consist #1 310 and allow consist #2 330 to precede it onto the merged track 360. Such a decision would be expected to delay operations for consist #1 310, but the delay may have nominal implications compared to the possibility of a significantly longer delay for both consists #1 310 and #2 330 should the decision be made to schedule consist #1 310 onto the merged track 360 ahead of consist #2 330. In prior art scheduling systems, the behavior of the crew was not taken into account, and in the present example, consist #1 310 would always be scheduled to precede consist #2 330 onto the merged track 360. Thus, by modeling each specific crew's behavior, important information can be collected and utilized to more precisely plan the movement of trains.

The behavior of a specific crew can be modeled as a function of the past performance of the crew. For example, a data base may be maintained that collects train performance information mapped to each individual member of a train crew. This performance data may also be mapped to the rail conditions that existed at the time of the train movement. This collected data can be analyzed to evaluate the past performance of a specific crew in the specified rail conditions and can be used to predict the future performance of the crew as a function of the predicted rail conditions. For example, it may be able to predict that crew A typically operates consist Y ahead of schedule for the predicted rail conditions, or more specifically when engineer X is operating consist Y, consist Y runs on average twelve minutes ahead of schedule for the predicted rail conditions.

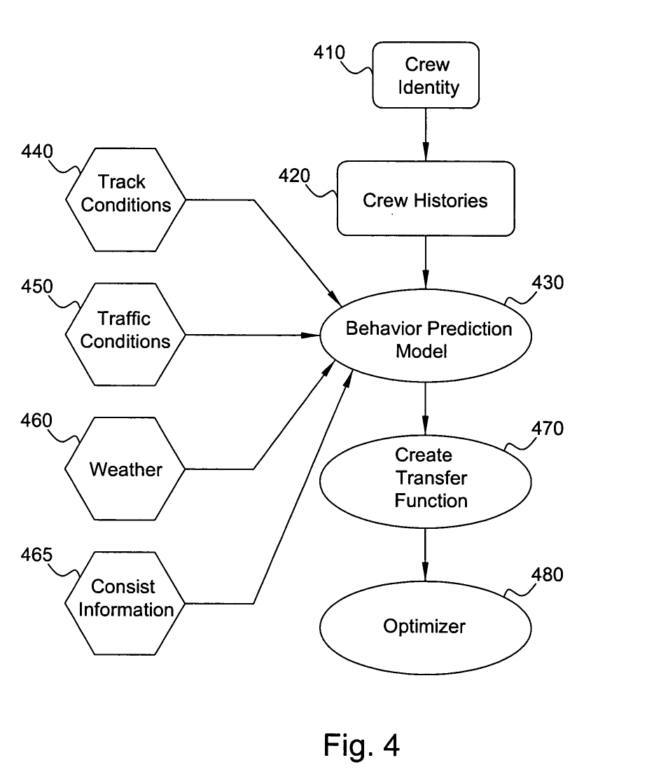

FIG. 4 illustrates one embodiment of the present disclosure for planning the movement of trains as a function of the behavior of the specific train crew. First the crew identity managing a particular consist is identified 410. This identity is input to the crew history database 420 or other storage medium or facility. The crew history database may contain information related to the past performance of individual crew members, as well as performance data for the combined individuals operating as a specific crew. The stored information may be repeatedly adjusted with each crew assignment to build a statistical database of crew performance. The crew history database 420 inputs the model coefficients for the particular crew model into the consist behavior prediction model 430. The model coefficients may be determined by historical parameters such as means and standard deviations of times required by a particular crew to travel standard distances at specific grades and measures of crew sensitivities to different and specific weather conditions. In one embodiment of the present disclosure, the model coefficients may be determined by statistical analysis using multivariant regression methods. Track condition information 440, track traffic conditions 450, weather conditions 460, and consist information 465, are also input to the behavior prediction model 430. The behavior prediction model 430 is run and its output is used to calculate a transfer function 470 that will supply the optimizer 480 with statistics respecting the expected behavior of the train such as its expected time to reach a rail point, the variance of the prediction, and other predicted data of interest. The optimizer 480 will be used to optimize the movement of the trains as a function of some objective function such as lowest cost, fewest exceptions, maximum throughput, minimum delay.

The embodiments disclosed herein for planning the movement of the trains can be implemented using computer usable medium having a computer readable code executed by special purpose or general purpose computers.

While embodiments of the present disclosure have been described, it is understood that the embodiments described are illustrative only and the scope of the disclosure is to be defined solely by the appended claims when accorded a full range of equivalence, many variations and modifications naturally occurring to those of skill in the art from a perusal hereof.

What is claimed:

1. A method of predicting the performance of the movement of trains over a rail network comprising the steps of:
(a) generating a movement plan for a first train;
(b) assigning a crew to operate the first train;
(c) monitoring the performance of the movement of the first train against the movement plan as a function of the assigned crew;
(d) monitoring conditions of the railway;
(e) storing information related to the monitored performance and the monitored conditions of the railway;
(f) predicting the performance of the movement of a second train as a function of the stored information.

2. The method of claim 1 further comprising the step of scheduling the movement of the second train as a function of the predicted performance of the second train.

3. The method of claim 1 wherein the step of monitoring the performance of the first train includes comparing the actual movement of the first train with the movement plan of the first train.

4. The method of claim 1 wherein the rail network is divided into a plurality of track elements and wherein the step of monitoring the performance of the first train includes comparing the actual movement of the first train with the movement plan of the first train over each track element that the first train traverses.

5. The method of claim 1 wherein the railway conditions include at least one of traffic conditions, weather conditions, time of day, seasonal variances, physical characteristics of the train and dispatcher efficiency.

6. The method of claim 1 wherein the stored information is repeatedly adjusted with each crew assignment to build a statistical database of crew performance.

7. A method of scheduling the movement of plural trains over a rail network, each train having an assigned crew to operate the train comprising the steps of:
(a) maintaining a database of information related to the past performance of the movement of a first train as a function of the crew assigned to operate the first train; and
(b) scheduling the movement of a second train as a function of the information in the database.

8. The method of claim 7, wherein the step of maintaining a database of information related to the past performance of the movement of a first train includes comparing the actual movement of the first train with the movement plan of the first train.

9. The method of claim 7 wherein the step of scheduling the movement includes:
(i) assigning a second crew to operate the second train;
(ii) predicting a behavior of the second crew as a function of the information maintained in the database;
(iii) predicting the performance of the movement of the second train as a function of the predicted behavior of the crew.
(iv) scheduling the second train as a function of the predicted performance.
